(19) United States
(12) Patent Application Publication
(10) Pub. No.: US 2013/0124579 A1
(43) Pub. Date: May 16, 2013

(54) SHOWING SYSTEM FOR PRODUCT MATERIALS AND SHOWING METHOD THEREFOR

(71) Applicants: Chun-Hua Chiu, Taipei City (TW); Chao-Hsin Wang, Taipei City (TW); Hsiao-Yen Chu, Taipei City (TW); Shu-Hui Huang, Taipei City (TW)

(72) Inventors: Chun-Hua Chiu, Taipei City (TW); Chao-Hsin Wang, Taipei City (TW); Hsiao-Yen Chu, Taipei City (TW); Shu-Hui Huang, Taipei City (TW)

(73) Assignee: INVENTEC CORPORATION, Taipei City (TW)

(21) Appl. No.: 13/313,916

(22) Filed: Dec. 7, 2011

(30) Foreign Application Priority Data
Nov. 11, 2011 (TW) 100141250

(51) Int. Cl. G06F 7/00

(52) U.S. Cl. 707/803; 707/E17.005; 707/E17.044

(57) ABSTRACT

A showing system and a showing method for product materials are provided. In this showing method, a material module database is created and stored, which includes a number of three-dimensional material modules corresponding to a number of material information and a number of module class information corresponding to the material information. A preview database is created, which includes the material information, a number of preview modules and a number of preview class information corresponding to the material information. The preview modules and preview class information in the preview database are timingly adjusted according to the three-dimensional material modules and the class information in the material module database. A user interface receives the material information to display the corresponding preview modules and the preview class. The material management personnel can thus utilize the user interface to view and search for material information, thereby increasing the material management quality and efficiency.

### CROSS-REFERENCE TO RELATED APPLICATION

This application claims the priority benefit of Taiwan application serial no. 100141250, filed on Nov. 11, 2011. The entirety of the above-mentioned patent application is hereby incorporated by reference herein and made a part of this specification.

### BACKGROUND OF THE INVENTION

1. Field of the Invention

The present invention relates to a management technology for product materials, and more particularly, to a showing method for product materials.

2. Description of Related Art

Nowadays, tech-products are being updated rapidly, and customers are demanding an increasingly higher level of diversity and difference of the products. Therefore, in order to quickly meet the customers' needs, brand companies wish to be able to quickly provide various products' designs and requirements to the OEM manufacturers, and wish the OEM manufacturers to be able to quickly manufacture and ship the products according to their requests.

Therefore, many manufacturers wish each of product materials and the assembling relationship among these materials to be clearly shown to the research and development personnel and material management personnel so as to reduce the errors in creating a bill of material (BOM). A BOM error severely affects the material preparation, production and assembly of the product, thus significantly delaying the product shipment. However, when creating the BOM, the material management personnel can only see a heap of material model numbers in the material database, without knowing the structure and shape of and the assembly relationship among various materials. As a result, issues such as an incorrect material model number being pulled out from the material database to the BOM or the inability of clearly showing the assembly relationship among the materials may occur in creating the BOM.

### SUMMARY OF THE INVENTION

Accordingly, the present invention is directed to a showing system and a showing method for product materials, which allow the material management personnel to quickly view three-dimensional modules of the product materials through a user interface, thereby allowing for a quick search for material information and avoiding errors in creating a BOM.

The present invention provides a showing system for product materials. The showing system includes a module unit, a material preview unit and an intermediary unit. The module unit is used create and store a material module database. The material module database includes a plurality of three-dimensional material modules corresponding to a plurality of material information and a plurality of module class information corresponding to the plurality of material information. The material preview unit includes a preview database and a user interface. The preview database includes the material information, a plurality of preview modules and a plurality of preview class information corresponding to the material information. The user interface receives the material information to display the corresponding preview modules and the preview class information. The intermediary unit timingly adjusts the preview modules and preview class information in the preview database according to the three-dimensional material modules and the class information in the material module database.

In one embodiment, the module unit includes three-dimensional module creating software for creating and maintaining the material module database.

In one embodiment, the three-dimensional module creating software is Intralink software, and the material module database is an Oracle database.

In one embodiment, the intermediary unit includes a data temporary storage device and executes a timing synchronization program. Execution of the timing synchronization program includes timingly retrieving and comparing the material module database with the preview database; reading and storing the three-dimensional material modules and class information that are changed to the data temporary storage device; in the data temporary storage device, converting the three-dimensional material modules and class information to the preview modules and preview class information in a format complying with the preview database; and writing the converted preview modules and class information back into the preview database of the material preview unit.

In one embodiment, the user interface further displays a combination for parts of the corresponding three-dimensional material modules according to the module class information.

In one embodiment, the module unit, the material preview unit and the intermediary unit are connected over a local area network.

The present invention provides a showing method for product materials. In this showing method, a material module database is created and stored, wherein the material module database includes a plurality of three-dimensional material modules corresponding to a plurality of material information and a plurality of module class information corresponding to the plurality of material information. A preview database is created, wherein the preview database includes the material information, a plurality of preview modules and a plurality of preview class information corresponding to the material information. Afterwards, the preview modules and preview class information in the preview database are timingly adjusted according to the three-dimensional material modules and the class information in the material module database. A user interface receives the material information to display the corresponding preview modules and the preview class.

In one embodiment, the material module database is created and maintained by three-dimensional module creating software.

In one embodiment, timingly adjusting the preview database according to the material module database further includes timingly retrieving and comparing the material module database with the preview database; reading and storing the three-dimensional material modules and class information that are changed to a data temporary storage device of an intermediary unit; in the data temporary storage device, converting the three-dimensional material modules and class information to the preview modules and preview class information in a format complying with the preview database; and writing the converted preview modules and class information back into the preview database.

In one embodiment, the showing method further includes displaying a combination for parts of the corresponding three-dimensional material modules according to the module class information using the user interface.

In view of the foregoing, the intermediary unit of embodiments of the present invention timingly and automatically synchronizes the changed material module in the material module database of the module unit to the preview database of the preview unit. Therefore, the material management personnel can easily view and search for information such as three-dimensional modules and class information of the materials, thus avoiding the issues such as an incorrect material model number being pulled out from the material module database to the BOM or the inability of clearly showing the assembly relationship among the materials during manually creating the BOM.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a showing system for product materials according to one embodiment of the present invention.

FIG. 2 is a flow chart of a showing method for product materials according to one embodiment of the present invention.

FIG. 3 is a flow chart of a method of a timing synchronization program according to one embodiment of the present invention.

FIG. 4 illustrates a showing system for product materials according to one embodiment of the present invention.

FIG. 5 illustrates a showing system for product materials according to another embodiment of the present invention.

### DESCRIPTION OF THE EMBODIMENTS

The product research and development personnel and material management personnel often belong to different groups. Therefore, the material management personnel can only use the material model numbers to create a bill of material (BOM) by a rule of thumb, which often leads to an error. In order to allow the material management personnel to quickly view and search for the material information and reduce the issues such as an incorrect material model number being pulled out to the BOM or the inability of clearly showing the assembly relationship among the materials in creating the BOM, embodiments of the present invention automatically synchronizes a preview database used by the material management personnel with a material module database used by the research and development personnel, such that the material management personnel can easily view and search for information such as three-dimensional modules and class information of the materials, thus avoiding the issues such as an incorrect material model number being pulled out from the material module database to the BOM or the inability of clearly showing the assembly relationship among the materials during manually creating the BOM. Below, several relevant embodiments within the spirit of the present invention are described.

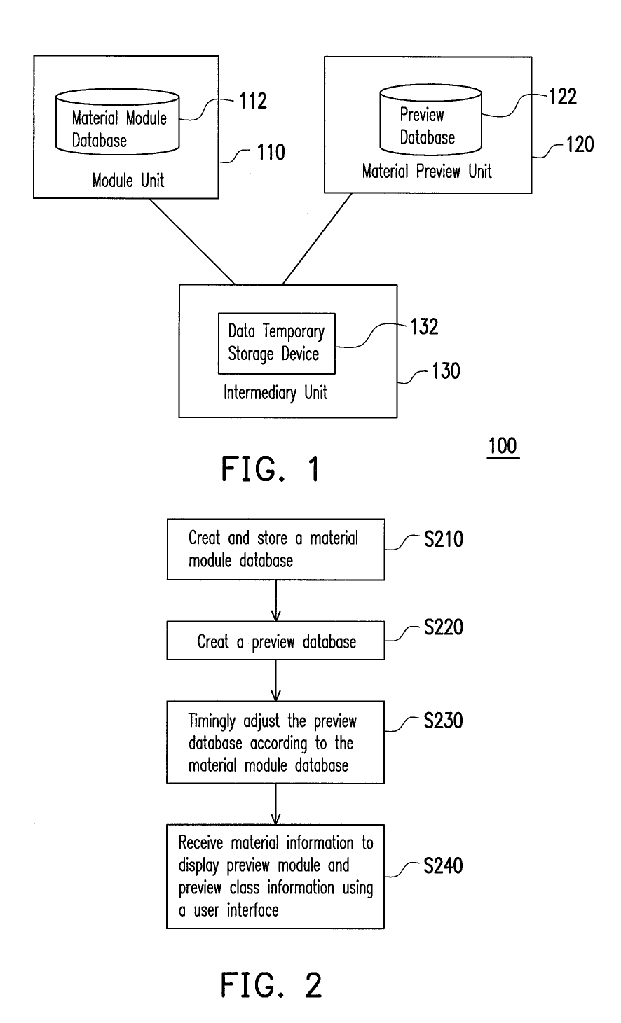

FIG. 1 illustrates a showing system for product materials according to one embodiment of the present invention. Referring to FIG. 1, the product material showing system 100 includes a module unit 110, a material preview unit 120 and an intermediary unit 130. In the present embodiment, the module unit 110, material preview unit 120 and intermediary unit 130 are installed in three different computer hosts, respectively. These computer hosts can be connected with each other over a local area network. The function of each block of the product material showing system 100 is described below.

The module unit 110 includes a material module database 112. The material module database 112 provides the research and development personnel with material-related information, such as, material model numbers, three-dimensional material models, combination relationship among various materials, or the like, of each product. Therefore, the material module database 112 includes three-dimensional material modules corresponding to material information (e.g. material model numbers) and module class information corresponding to the material information. The material preview unit 120 includes a preview database 122. The material preview database 122 records the material information, and a plurality of preview modules and a plurality of preview class information corresponding to the material information. The intermediary unit 130 includes a data temporary storage device 132. The intermediary unit 130 timingly retrieves and compares material data in the material module database 112 with material data in the preview database 122, stores the three-dimensional material modules and class information that are found to have changed through comparison to the data temporary storage device 132, converts these changed three-dimensional material modules and class information into preview modules and preview class information in a format complying with the preview database 122, and then writes these converted preview modules and preview information back into the preview database 122.

The workflow of the product material showing system 100 is described below in greater detail in connection with another embodiment. Below, the workflow of a showing method for product materials is described in conjunction with the product material showing system 100 of FIG. 1 and steps S210 to S240 of FIG. 2. Referring to FIG. 1 and FIG. 2, at step S210, the product research and development personnel first create the material module database 112 in the module unit 110 by using three-dimensional structure design and three-dimensional module creating software such as, Intralink and Pro/E. Therefore, the material module database 112 not only stores the three-dimensional material module corresponding to each material information (e.g. material model number) and the material information, but it also records the combination relationship among relevant material model numbers. For example, the model number of a mechanical material formed by combining a plurality of small mechanical materials includes the model numbers of the small mechanical materials and the combination relationship thereamong. This combination relationship among the material modules is the above-mentioned module class information.

At step S220, a preview database 122 is then created in the material preview unit 120 used by the material management personnel. This preview material module database 122 stores various material information (e.g. material model numbers), preview modules corresponding to the material model numbers, and preview class information among the material model numbers, such as, the combination relationship among multiple mechanical materials, perspective views corresponding to the material model numbers, or the like.

The material module database 112 in the module unit 110 stores many and diverse information, whereas the preview database 122 in the preview unit 120 needs only store the preview modules corresponding to the material model numbers and their preview class information. Therefore, at step S230, the intermediary unit 130 executes a timing synchronization program to timingly detect the three-dimensional modules and class information in the material module database 112 to determine whether there is any information changed. The three-dimensional material modules and class information thereof that are changed relative to a previous synchronization are temporarily stored and converted, such that the changed three-dimensional material modules and class information thereof are synchronized to the corresponding preview modules and preview class information in the preview database 122.

At step S240, users (e.g. the material management personnel) may preview the material information (e.g. various material model numbers and the class information thereamong) in the preview database 122 through a user interface provided by the material preview unit 120, and the preview modules and preview class information corresponding to the material model numbers are displayed through this user interface.

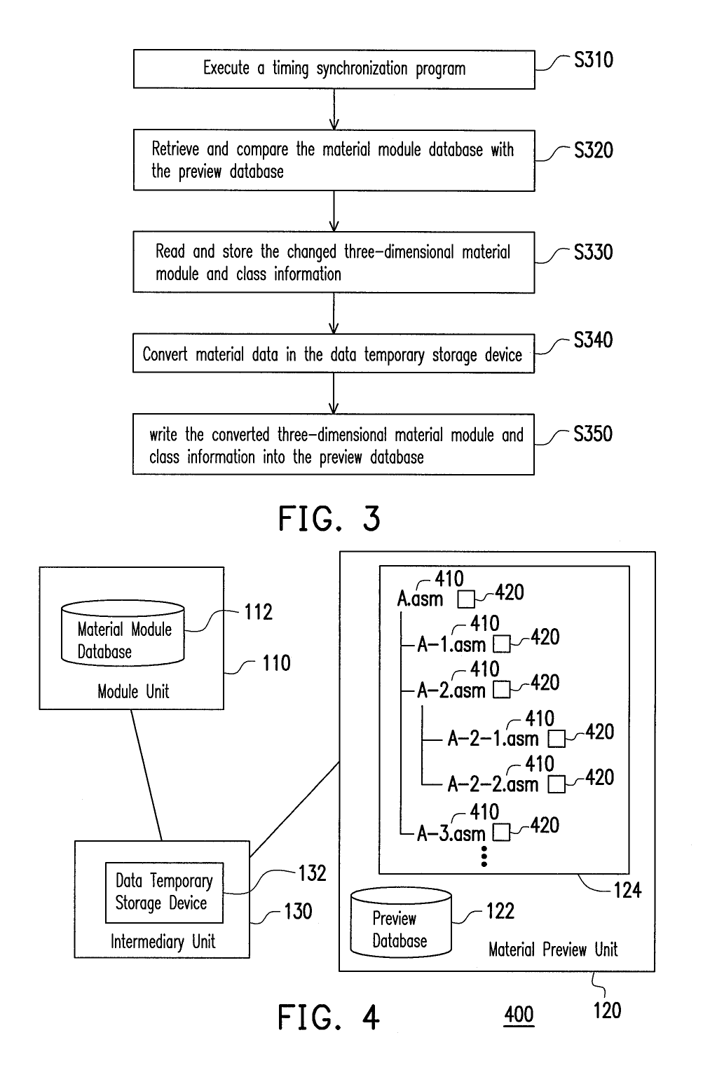

The workflow of the product material showing system 100 is further described below in connection with another embodiment which describes a workflow of the timing synchronization program in the intermediary unit 130. Referring to FIG. 1 and FIG. 3, at step S310, the intermediary unit 130 first executes the timing synchronization program. The timing synchronization program is executed as follows. At step S320, the timing synchronization program logs into the material module database 112 of the module unit 110 using preset login information such as database name, user name and user password or the like at a periodic fixed time (e.g. the program is executed once a day) to retrieve and store the three-dimensional material modules and module class information corresponding to the material information in the material module database 112 to the data temporary storage device 132 of the intermediary unit 130. For example, the intermediary unit 130 executes the program to automatically download all data sheets in the material data 112 to the data temporary storage device 132.

At the same time, this timing synchronization program also logs into the preview database 122 of the material preview unit 120 using preset login information, and retrieves and stores the preview modules and preview class information in the preview database 122 to the data temporary storage device 132 of the intermediary unit 130. For example, the intermediary unit 130 executes the program to automatically download all data sheets in the preview database 122 to the data temporary storage device 132. Afterwards, the timing synchronization program compares the three-dimensional material modules and module class information corresponding to the material information in the data temporary storage device 132 that are retrieved from the material module database 112 with the preview modules and preview class information in the data temporary storage device 132 that are retrieved from the preview database 122.

Afterwards, at step S330, the timing synchronization program reads the three-dimensional material modules and class information that are found to have changed through comparison and re-stores these changed three-dimensional material modules and class information to the data temporary storage device 132, while the rest unchanged data downloaded to the data temporary storage device 132 is automatically deleted by the program after the data comparison is completed. Afterwards, at step S340, the three-dimensional material modules and class information still stored in the data temporary storage device 132 are converted to preview modules and preview class information in a data format complying with the preview database 122 according to a preset format conversion rule, for example, the conversion is performed only with respect to data in specific data fields of the material information and material class information, and those unnecessary material information is eliminated. At step S350, the format-converted three-dimensional material modules and class information are written back into the preview database 122 of the preview unit 120 to update the preview modules and preview class information corresponding to the material information in the preview database 122 according to the data sheet and data field format required by the preview database 122. Execution of the timing synchronization program is thus completed.

In addition, a program in the material preview unit 120 may automatically read the data content in the preview database 122, and automatically generate a user interface 124 based on the data content, as shown in FIG. 4. FIG. 4 illustrates a product material showing system 400 according to one embodiment of the present invention. The user interface 124 provides the users (i.e. material management personnel) with a simple visualized interface which enables a clear search for the three-dimensional modules for each material and the class relationship among various three-dimensional modules. The user interface 124 may display the class relationship among various material model numbers 410 and material modules, for example, “A.asm”, “A-1.sam to A-3.asm” and “A-2-1.sam to A-2-2.asm”. The users may click a three-dimensional module preview button 420 to the right of each material model number 410 to display the three-dimensional module corresponding to each material, such as, a three-dimensional figure allowing the users to view from various angles.

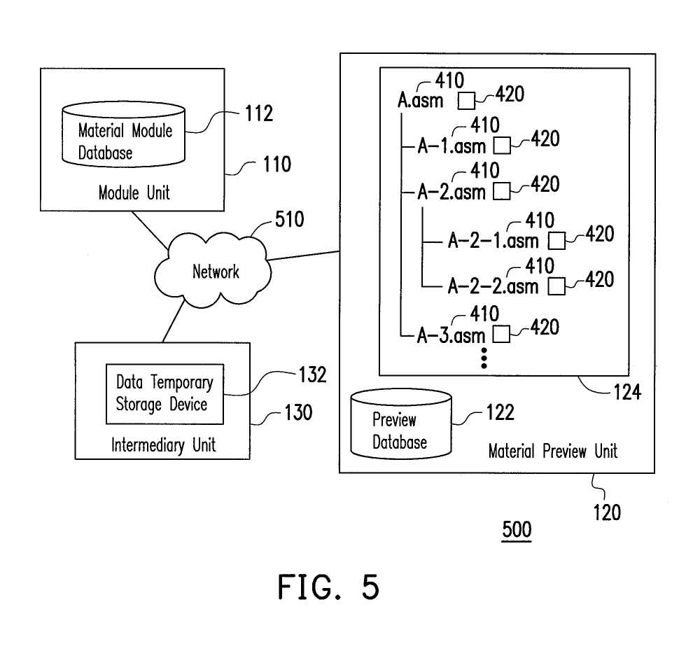

FIG. 5 is a block diagram of a product material showing system 500 according to another embodiment of the present invention. In the present embodiment, the product material showing system 500 includes a module unit 110, a material preview unit 120, and an intermediary unit 130. The difference between this embodiment and the previous embodiment lies in that the module unit 110, material preview unit 120 and intermediary unit 130 of the present embodiment are coupled to each other over a network 510. Therefore, during execution of the timing synchronization program, the timing synchronization program is connected over the network to a host in which the module unit 110 is installed at a periodic fixed time (e.g. the program is executed once a day), logs into the material module database 112 of the module unit 110 using preset login information such as the database name, user name and user password or the like, and retrieves and stores the three-dimensional material modules and module class information corresponding to the material information in the material module database 112 to the data temporary storage device 132 of the intermediary unit 130.

At the same time, this timing synchronization program is also connected over the network to a host in which the material preview unit 120 is installed, logs into the preview database 122 of the material preview unit 120 using the preset login information, and retrieves and stores the preview modules and preview class information in the preview database 122 to the data temporary storage device 132 of the intermediary unit 130. Afterwards, the timing synchronization program compares the three-dimensional modules and module class information corresponding to the material information in the data temporary storage device 132 that are retrieved from the material module database 112 with the preview modules and preview class information in the data temporary storage device 132 that are retrieved from the preview database 122. The present embodiment is similar to the above embodiments in execution of the timing synchronization program and, therefore, explanation of those same steps of the execution of the timing synchronization program is not repeated herein.

In addition, the three-dimensional module creating software (Intralink) used by the research and development personnel is proprietary software requiring a license. If the material management personnel also use the same software, it would increase the cost of material management. Therefore, this three-dimensional module creating software is not required in the material preview unit of embodiments of the present invention, which can reduce the number of the licenses of the three-dimensional module creating software, thus reducing the cost.

In summary, the product material showing system of the present invention utilizes a timing synchronization program to compare a material module database with a preview database to determine whether there is any material information changed, and synchronize those changed material information to the preview database. The material management personnel can utilize a user interface provided by the system to timely view and search for material information stored in the preview database, thus increasing the material management quality and efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A showing system for product materials, comprising:
a module unit creating and storing a material module database, wherein the material module database comprises a plurality of three-dimensional material modules corresponding to a plurality of material information and a plurality of module class information corresponding to the plurality of material information;
a material preview unit comprising a preview database and a user interface, wherein the preview database comprises the material information, a plurality of preview modules and a plurality of preview class information corresponding to the material information, and the user interface receives the material information to display the corresponding preview modules and the preview class information; and
an intermediary unit timingly adjusting the preview modules and preview class information in the preview database according to the three-dimensional material modules and the class information in the material module database.

2. The showing system for product materials according to claim 1, wherein the module unit comprises three-dimensional module creating software for creating and maintaining the material module database.

3. The showing system for product materials according to claim 1, wherein the intermediary unit comprises a data temporary storage device and executes a timing synchronization program, and execution of the timing synchronization program comprises:
timingly retrieving and comparing the material module database with the preview database;
reading and storing the three-dimensional material modules and class information that are changed to the data temporary storage device;
in the data temporary storage device, converting the three-dimensional material modules and class information to the preview modules and preview class information in a format complying with the preview database; and
writing the converted preview modules and class information back into the preview database of the material preview unit.

4. The showing system for product materials according to claim 1, wherein the user interface further displays a combination for parts of the corresponding three-dimensional material modules according to the module class information.

5. The showing system for product materials according to claim 1, wherein the module unit, the material preview unit and the intermediary unit are connected over a network.

6. A showing method for product materials, comprising:
creating and storing a material module database, wherein the material module database comprises a plurality of three-dimensional material modules corresponding to a plurality of material information and a plurality of module class information corresponding to the plurality of material information;
creating a preview database, wherein the preview database comprises the material information, a plurality of preview modules and a plurality of preview class information corresponding to the material information; and
timingly adjusting the preview modules and preview class information in the preview database according to the three-dimensional material modules and the class information in the material module database; and
receiving the material information to display the corresponding preview modules and the preview class information using a user interface.

7. The showing method for product materials according to claim 6, wherein the material module database is created and maintained by three-dimensional module creating software.

8. The showing method for product materials according to claim 6, wherein timingly adjusting the preview database according to the material module database further comprises:
timingly retrieving and comparing the material module database with the preview database;
reading and storing the three-dimensional material modules and class information that are changed to a data temporary storage device of an intermediary unit;
in the data temporary storage device, converting the three-dimensional material modules and class information to the preview modules and preview class information in a format complying with the preview database; and
writing the converted preview modules and class information back into the preview database.

9. The showing method for product materials according to claim 6, further comprising displaying a combination for parts of the corresponding three-dimensional material modules according to the module class information using the user interface.
